(19) United States
(12) Patent Application Publication
(10) Pub. No.: US 2004/0088868 A1
(43) Pub. Date: May 13, 2004

(54) Cutting device

(76) Inventor: Michael C. Fazio, Oshawa (CA)

Correspondence Address: Mark B. Eisen, Dimock Stratton Clarizio LLP, 20 Queen Street West, Suite 3202, Box 102, Toronto, ON, M5H 3R3, CA

(21) Appl. No.: 10/289,333

(22) Filed: Nov. 7, 2002

(51) Int. Cl. B26B 3/00

(52) U.S. Cl. 30/294; 30/286

(57) ABSTRACT

A cutting device provides for hands free cutting of a material such as thread, string, line, filament and rope. The cutting device is generally an L-shaped device, which includes a blade contained within a housing that is connected to a back support at an angle, which provides sufficient clearance for material to be inserted into a slot within the housing and cut against a cutting edge of the blade. The back support is provided with an attachment means for attaching the back support to a fixed object thereby facilitating hands-free cutting.

### FIELD OF THE INVENTION

The invention relates to the field of cutting devices and in particular to cutting devices that can be attached to a person's clothing and can be used to cut materials such as thread, string, line, filament and rope hands-free.

### BACKGROUND OF THE INVENTION

It is difficult to cut materials such as thread, string, line, filament and rope using conventional cutting means such as scissors, knives or blades because only one hand can be used to hold the thread, string, line, filament or rope while the other line must be used to operate the cutting device. Once cutting is complete, only one end of the line is held while and the main line is often lost or tangled from the release of tension within the line resulting from the cut. Cuts are often inaccurate as insufficient tension is given to the thread, string, line, filament or rope during cutting.

While cutting devices exist that can be clipped to a person's clothing, these cutting devices are awkward to use unless they are unclipped from the person's clothing. Where exposed blades are also involved unclipping is necessary to ensure that cutting is done safely.

There therefore remains a need to provide a cutting device that can attached to a person's clothing or to a fixed object and can be used to cut materials such as thread, string, line, filament and rope hands-free.

### SUMMARY OF THE INVENTION

According to one aspect of the invention, there is provided a cutting device comprising: a blade with at least one exposed cutting edge; a housing, housing said blade and providing a relief edge to guide a material to be cut toward the cutting edge; a back support connected to said housing at an angle which provides sufficient clearance to cut said material; wherein said back support is provided with an attachment means for attaching the back support to a fixed object thereby facilitating hands-free cutting by said cutting edge.

The cutting tool of the present invention has many advantages. In particular, the use of the cutting device facilitates hands-free cutting of thread, string, line, filament and rope making cutting of thread, string, line, filament and rope easier and more accurate.

Numerous other advantages will be apparent to the person skilled in the art when the details of the present invention are read in conjunction with its drawings.

### BRIEF DESCRIPTION OF THE DRAWINGS

The preferred embodiments of the present invention will now be described in greater detail with reference to the accompanying drawings, in which:

FIG. 1 is a side perspective view of a first embodiment of the cutting device.

FIG. 2 is a side view of the cutting device of FIG. 1.

FIG. 3 is a side perspective view of a further embodiment of the cutting device wherein the attachment means is a pair of transverse slots.

FIG. 4 is a side perspective view of a further embodiment of the cutting device in which the cutting edge is parallel to the relief edge.

### DETAILED DESCRIPTION OF THE PREFERRED EMBODIMENTS

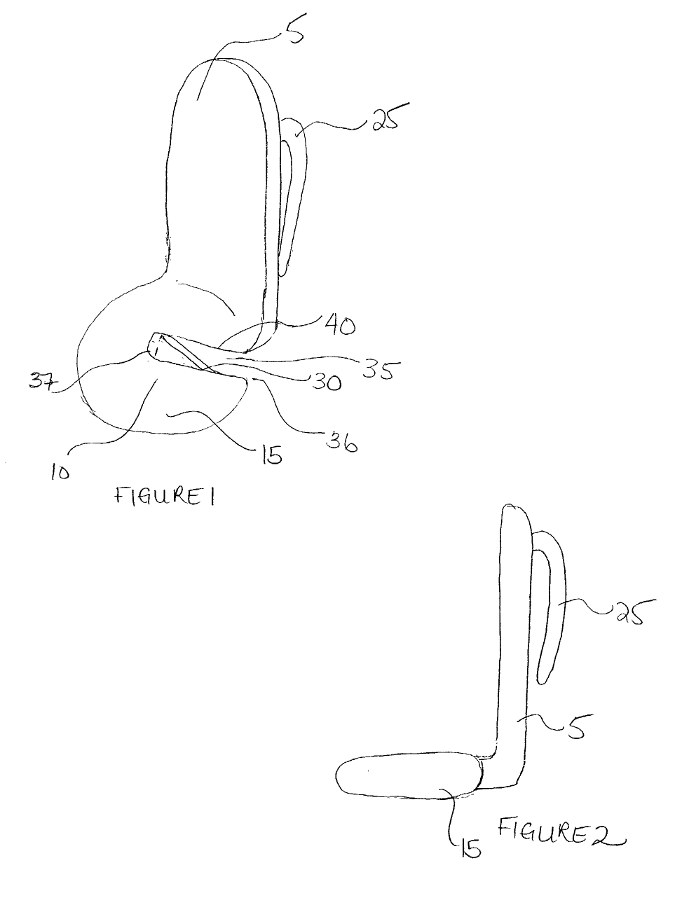

Referring to FIG. 1, the cutting device of the present invention comprises a back support 5 connected to a blade 10, which is housed within a housing 15. The housing 15 provides a relief edge 40 to the blade 10 for cutting. The back support 5 is facilitated with an attachment means 25 for attaching the cutting device to a person's clothing.

In a preferred embodiment of the present invention, the cutting device is a generally L-shaped device. The back support 5 is generally rectangular in shape and may be contoured for easy attachment to a person's body or a fixed object.

Blade 10 is a generally rectangular blade. Blade 10 is housed within the housing 15, which provides a protective shell for the blade 10.

Housing 15 is preferably integrally connected to the back support 5, but may be connected to the back support 5 by attachment of separate parts. Housing 15 lies at an angle relative to the back support 5, which provides sufficient clearance for cutting. Preferably the housing 15 is at an angle relative to the back support 5 of from about 30 degrees to about 150 degrees. More preferably the housing is at an angle relative to the back support 5 from about 70 degrees to about 110 degrees, and more preferably from about 85 degrees to about 95 degrees as shown in FIGS. 1 to 4.

At least a portion of blade 10 is exposed from the housing 15 to provide a cutting edge 30. Cutting edge 30 lies within a cutting track 35 of the housing 15. In a preferred embodiment, cutting track 35 is a slot with a first open end 36 and a second fixed end 37.

When in use therefore, the material to be cut is inserted into the first open end 36 of the cutting track 35 until it reaches a temporary holding point which lies somewhere along the cutting track 35 toward the second fixed end 37. The material is then angled toward the cutting edge 30 to cut the material against the cutting edge 30.

Cutting edge 30 is located within a first side of the cutting track 35 opposite the relief edge 40. Relief edge 40 helps to retain the material within the cutting track 35.

Cutting edge 30 is preferably maintained at an acute angle within the cutting track 35 (as shown in FIGS. 1 to 3) but may lie parallel to the relief edge 40 as shown in FIG. 4. It will be apparent to the person skilled in the art that the cutting edge 30 may also be located within the second fixed end 37, providing a cutting edge 30 that is perpendicular to the relief edge 40 without deviating from the invention as claimed.

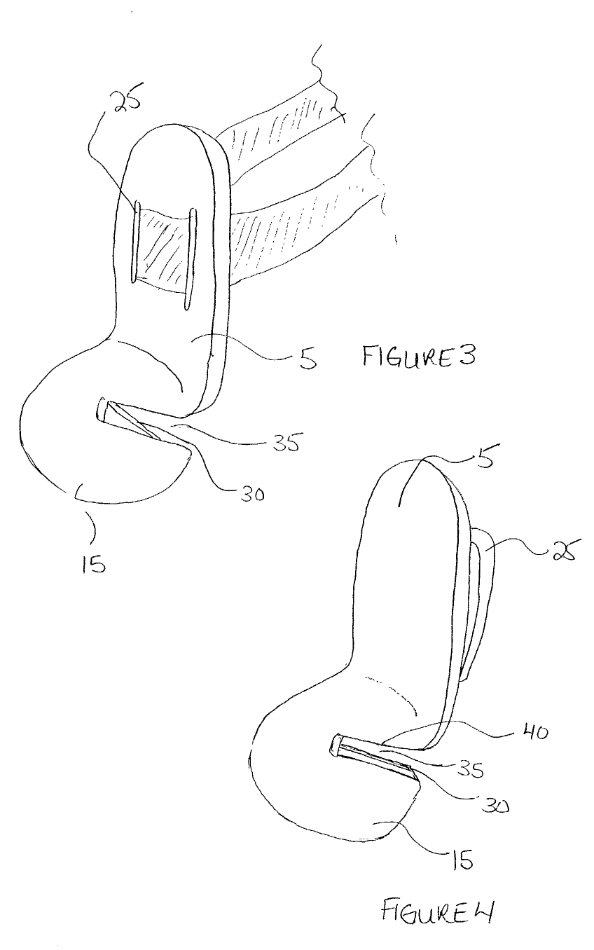

As best shown in FIG. 2, the back support 5 can be molded with a suitable attachment means 25 such as a hook or clip for easy attachment of the back support to a person's body to allow for hands-free cutting. It will be apparent to one skilled in the art however that any suitable attachment means can be affixed to the back support 5, including clips, pins or Velcro™ fasteners without deviating from the invention as claimed. The back support 5 may also be adapted with a pair of transverse slots at opposite sides of the back support (FIG. 3) into which a string or tie could be inserted to facilitate strapping the back support 5 to a person's body or a fixed object.

The cutting device of the present invention can therefore be worn and used as an effective hands-free cutter. The cutting device is most advantageous for cutting materials that require tension for cutting such as thread, string, line, filament and rope and which need to be held with two hands while being cut. However, it will be apparent that the cutting device can also be used to cut numerous other materials, including tubing, plastics and paper in an easy to use and efficient manner.

It will be apparent to the person skilled in the art that the back support 5 and housing 15 of the cutting device may be molded in many different shapes and sizes without deviating from the invention as claimed.

Numerous other modifications and alterations to the cutting device of the present invention can be contemplated and are within the scope of the present invention and its claims.

We claim:

1. A cutting device comprising:
a blade with at least one exposed cutting edge;
a housing, housing said blade and providing a relief edge to guide a material to be cut toward the cutting edge;
a back support connected to said housing at an angle which provides sufficient clearance to cut said material;
wherein said back support is provided with an attachment means for attaching the back support to a fixed object thereby facilitating hands-free cutting by said cutting edge.

2. The cutting device of claim 1, wherein said back support is connected to said housing at an angle between about 30 degrees and about 150 degrees.

3. The cutting device of claim 2, wherein said back support is connected to said housing at an angle from about 70 degrees to about 110 degrees.

4. The cutting device of claim 3, wherein said back support is connected to said housing at an angle from about 85 degrees to about 95 degrees.

5. The cutting device of claim 1 wherein the back support is integrally attached to said housing.

6. The cutting device of claim 1, wherein said attachment means is a clip, hook or fastener.

7. The cutting device of claim 6, wherein said attachment means is integrally connected to said back support.

8. The cutting device of claim 1, wherein said attachment means is a pair of transverse slots, said transverse slots configured to allow a strap to be inserted therethrough.

9. The cutting device of claim 1, wherein said cutting edge is at an acute angle relative to said relief edge.

10. The cutting device of claim 1, wherein the cutting edge lies parallel to the relief edge.

11. The cutting device of claim 1, wherein the cutting edge lies perpendicular to the relief edge.

12. The cutting device of claim 1, wherein said cutting device can be attached to a person's clothing, a piece of furniture or a fixed object.
